(19) United States
(12) Patent Application Publication
(10) Pub. No.: US 2013/0093867 A1
(43) Pub. Date: Apr. 18, 2013

(54) ENDOSCOPE

(71) Applicant: Anton Schick, Velden (DE)

(72) Inventor: Anton Schick, Velden (DE)

(21) Appl. No.: 13/807,746

(22) PCT Filed: Jun. 22, 2011
(86) PCT No.: PCT/EP11/60406

§ 371 Date: Dec. 31, 2012

(30) Foreign Application Priority Data
Jun. 30, 2010 (DE) 102010025752.4

(51) Int. Cl. H04N 7/18

(52) U.S. Cl. CPC H04N 7/18
USPC 348/65

(57) ABSTRACT

Projection beams are emitted from a projection unit. An image generating unit associated with the projection unit generates phase-structured image sequences in close-up by a light-emitting display or at a distance by a projection module and downstream image guides, and transmits the sequences to the projection unit. In this manner, both alternatives allow sequences of phase-structured images, phase-shifted relative to each other, to be projected onto the surface to be measured and imaged by the projection unit, even under very spatially limited conditions. The latter alternative allows a battery-powered, capsule-shaped 3D measurement head to be inserted into cavities to be measured without any feeds (other than the guide wire). In this case, the battery powers both the micro display and the image sensor, wherein the image sensor data representing the reflection of the projected image can be either transmitted wirelessly or stored.

### CROSS REFERENCE TO RELATED APPLICATIONS

This application is based on and hereby claims priority to International Application No. PCT/EP2011/060406 filed on Jun. 22, 2011 and German Application No. 10 2010 025 752.4 filed on Jun. 30, 2010, the contents of which are hereby incorporated by reference.

### BACKGROUND

The invention relates to an endoscope for measuring the topography of a surface, and to a method for measuring the topography of a surface.

Conventional and well-understood techniques for measuring three-dimensional geometries are often based on active triangulation. However, in a constricted environment, such as e.g. in the human auditory canal or in drilled holes, it becomes ever more difficult to realize the triangulation as such. Particularly in the field of measuring endoscopy, it is not easy to position the spatial arrangement of transmission and reception units, or projection and imaging units at the appropriate angles. Moreover, it is generally impossible to record relatively long or relatively large cavities in one image. That is to say, it is necessary to measure, in three dimensions, spatially overlapping regions successively in time in order subsequently to combine these to a 3D structure by data processing (3D data stitching). The larger the overlapping regions are in this case, the more precisely it is possible to link individual recordings in 3D space. This likewise presupposes that the individual recordings per se already have a fixed relationship to one another at as many measuring points as possible.

The German patent applications 10 2009 043 523.9 and 10 2009 043 538.7 propose endoscopes for the human auditory canal or for the industrial field, which operate on the basis of color coded triangulation (CCT). However, CCT sadly has the disadvantage that three-dimensional measurement values can only be measured at the transitions of the color strips or color rings. Thus, in general, at least five camera pixels are required when visualizing the projected color pattern so that it is possible to reconstruct the color strips uniquely for calculating the 3D coordinates. It follows that the measurement resolution is approximately 5-times poorer than for the known phase triangulation. In phase triangulation, a strip pattern is projected which has a sinusoidal intensity modulation perpendicular to the stripes. If this pattern is then projected onto the surface to be measured and observed at a triangulation angle, the pattern becomes distorted depending on the three-dimensional topography of the surface. The shift of the phase angle of the sinusoidal modulation together with the triangulation angle provides corresponding height and distance values by a comparatively simple mathematical relationship. In order in turn to be able to measure the phase angle, the phase angle of the sinusoidal modulation pattern must be shifted in a defined fashion on the projection side (at least three phase angles are required). Thus, it is necessary to generate a set of phase-structured, but respectively mutually phase-shifted images, which are to be respectively recorded and analyzed. Since the intensity values of the recorded images should obey a sinusoidal profile for each camera pixel, it is possible to determine a height value for each pixel. This is how a five-times higher resolution is obtained than in CCT. However, in order to realize this principle for endoscopic applications, a slide interchange would have to be undertaken permanently in order to be able to realize the set of phase-shifted images and hence the various phase angles for the projection. As a result of the constricted spatial conditions in an endoscope head of the endoscopes mentioned at the outset, such an interchange cannot be realized or can only be realized with a disproportionate amount of effort.

### SUMMARY

One potential object is providing an endoscope for measuring surface topographies, which, compared to the related art, requires a smaller installation space and is able, for example when using active triangulation, to capture phase angle-shifted image sequences.

The inventor proposes an endoscope for measuring the topography of a surface comprises a projection unit and an imaging unit, wherein at least the projection unit is arranged in a measuring head which can be made to approach the surface to be measured. The endoscope furthermore comprises an image generating unit arranged outside of the measuring head, the images of which image generating unit can by the projection unit be directed at the surface to be measured, wherein the images of the image generating unit can be transmitted in a phase-structured fashion to the projection unit via an image guide.

A first alternative to the solution above includes an endoscope for measuring the topography of a surface, having a projection unit and an imaging unit, wherein at least the projection unit is arranged in a measuring head which can be made to approach the surface to be measured, wherein the projection unit comprises an image generating unit, which is embodied as light-emitting display which is able to emit phase-structured image sequences.

In respect of the method, the inventor proposes a method for measuring the topography of a surface by an endoscope, in which projection beams are emitted from a projection unit, wherein an image generating unit associated with the projection unit generates phase-structured image sequences near the head by a light-emitting display or at a distance from the head by an image generating unit and downstream image guide and transmits the image sequences to the projection unit.

This is how both alternatives render it possible to be able to project and image sequences of phase-structured and mutually phase-shifted images onto the surface to be measured by the projection unit, even in spatially very constricted conditions. The slide change required up until now for such a procedure for generating phase-shifted images has been eliminated thereby and replaced by the generation away from the head, which is only subject to easily controllable spatial restrictions, or by the generation near the head by the light-emitting display (micro-display). The latter alternative in particular renders it possible here to be able to insert a battery-powered capsule-shaped 3D measuring head into the cavities to be measured, such as e.g. the trachea, esophagus, intestines, auditory canal, without any feeds (except for an endoscope guide). In this case, the battery feeds both the micro-display and the image sensor, wherein the data from the image sensor, representing the reflection of the projected image, can be transmitted wirelessly to an evaluation unit, for example a visualization computer, or can be temporarily stored in the capsule-shaped measuring head itself.

In the case of the variant distant from the head, it is expedient if the image generating unit comprises a projection module. Thus, the image can be generated in the handling or control module of the endoscope for example. By way of example, liquid crystal on silicon (LCOS), DLP or LCD displays are suitable for this.

If the endoscope can be embodied as a rigid body, it is expedient if the image guide is embodied as a lens arrangement. Here, the lenses are typically arranged in a relay arrangement within a rigid tubular carrier.

Accordingly, the endoscope, in a flexible embodiment as a result of an expedient development, can have an image guide which is embodied as coherent fiber bundle. This variant, which is also advantageous in respect of receiving the reflection, also renders it possible to transmit images with a relatively large data volume (up to 1 MByte) into the projection unit via the image guide. In the case of an appropriate design, provision can even be made for returning the reflection of the images projected onto the surface to be measured via the coherent fiber bundle.

In an expedient development, it is advantageous for the second-mentioned variant if the light-emitting display is an OLED. OLED displays distinguish themselves by pixel dimensions which can be reduced to the extreme, as a result of which even a pixel-loaded image can be realized with a comparatively very small display cross section. However, in principle any type of LED array or other types of self-luminous arrays are feasible here, provided that they are able to satisfy the requirements in terms of pixel density.

In the case of radially symmetric measurement objects it is advantageous if a projection structure has a radially symmetric structure. Here, the projection structure can comprise an annular sinusoidal lattice, wherein provision is made for a radially outward sinusoidal profile from the center. Hence this design of the endoscope is particularly suitable for observing the esophagus and the trachea, as well as the intestines.

In a further advantageous embodiment, the imaging unit can have an imaging medium in the form of a sensor chip from a digital camera.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a schematic illustration of a measuring endoscope with a projection unit and an imaging unit for measuring a surface parallel or radially symmetric (cylindrical) to the endoscope axis, as per DE 10 2009 043 523.9;

FIG. 2 shows a schematic illustration of an endoscope as per DE 10 2009 043 523.9, with imaging unit and projection unit having opposite viewing directions;

FIG. 3 shows a schematic illustration of the projection unit with a beam path as per DE 10 2009 043 523.9;

FIG. 4 shows a schematic illustration of a first projection unit with a beam path and a phase-structured image projection by an image guide;

FIG. 5 shows a schematic illustration of a second projection unit with a beam path and a phase-structured image projection by a light-emitting display;

FIG. 6 shows a schematic illustration of a first endoscope with a projection unit with a beam path and a phase-structured image projection by image guides made of rod lenses;

FIG. 7 shows a schematic illustration of a second endoscope with a projection unit with a beam path and a phase-structured image projection by rod lenses for image feed and image return; and

FIG. 8 shows a capsule-shaped endoscope head with integrated projection unit.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

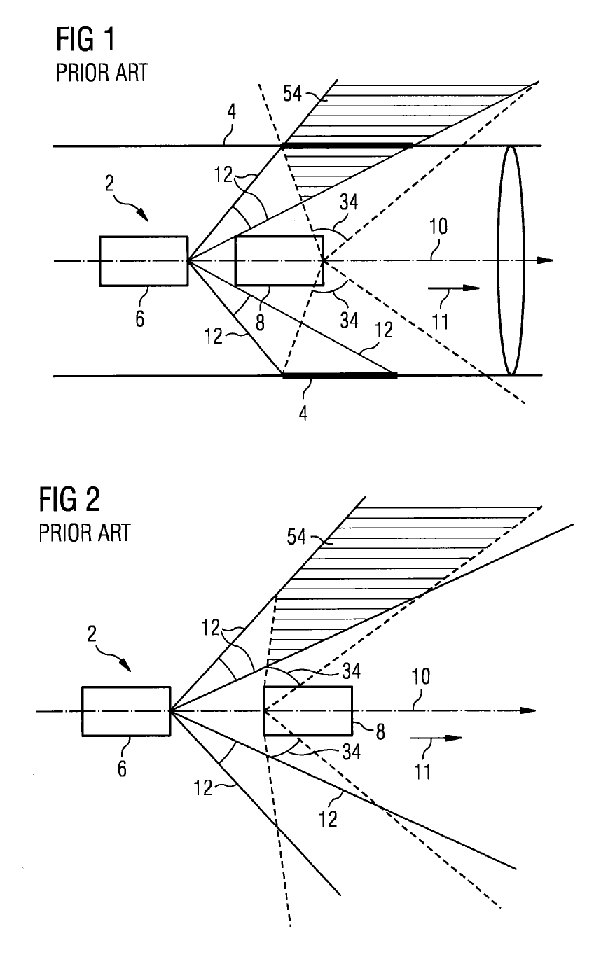

FIG. 1 illustrates the design of a 3D-measuring endoscope 2 with a projector unit 6 and an imaging unit 8, which lie in succession along an endoscope axis 10. The endoscope 2 serves to measure a surface 4. Here, the surface 4 can, as illustrated in FIG. 1, be a channel, for example an auditory canal of a human ear or a drilled hole, which is why the surface 4 is schematically illustrated as being cylindrical in FIG. 1. Naturally, the surface 4 to be measured has a complex shape in reality; the straight lines, which are provided with reference sign 4 in FIG. 1, merely serve for the schematic, drawn illustration.

In order to measure the topography of the surface 4, use is made of the method of triangulation. To this end, the projection unit 6 emits projection beams 12, which comprise different color spectra. These projection beams 12 impinge on the surface 4 and are reflected there. The imaging unit 8, as a result of a suitable imaging optical unit, in turn comprises a field of view 34, which is illustrated in FIG. 1 by the dashed lines. Here, it should be noted that both the projection beams 12 and the field of view 34, which are illustrated two-dimensionally in FIG. 1, are three-dimensional in reality and usually extend in a rotationally symmetric fashion.

The region which is encompassed by both the projection beams 12 and the field of view 34, i.e. the region in which projection beams 12 and field of view 34 intersect, is called the measurement region 54; it is illustrated by shading in FIGS. 1 and 2.

Measurement by a method of triangulation can only occur in the region in which projection beams 12 and field of view 34 intersect. The larger the embodiment of the measurement region 54 is, the larger the region is that can be performed in one measurement. It is often difficult, particularly in narrow cavities, to design the field of the projection beams and the field of view by known methods such that a sufficiently large measurement region 54 is formed.

The beam path described in FIGS. 1 and 2 can be achieved by the described series arrangement of the projection unit 6 and imaging unit 8 on the endoscope axis 10. The imaging unit 8, the viewing direction of which is identical to the viewing direction 11 of the endoscope (toward the right in FIG. 1), in turn has an advantageous embodiment of a very large field of view 34 (field of view). The field of view 34 of the imaging unit 8 can be more than 180°. It is expedient for the field of view 34, as a matter of principle, to have a larger angle than the maximum angle included by the projection beams.

FIG. 2 shows a measuring endoscope 2 which has the same series design (or in-line design) of projection unit 6 and imaging unit 8 on an endoscope axis 10; the projection unit 6 corresponds to the projection unit 6 from FIG. 1, just like the beam path of the projection beams 12. The only difference with respect to FIG. 1 relates to the fact that the imaging unit 8 is practically rotated by 180° and the field of view 34 thereof is designed such that the viewing direction of the imaging unit 8 is arranged opposite to the viewing direction 11 of the endoscope 2. Measurement by the method of triangulation takes place analogously to FIG. 1. A measurement region 54 is once again generated in the region of intersection between the projection beams 12 and the field of view 34. By way of example, this arrangement according to FIG. 2 can be applied if additional visualization is required in the viewing direction 11 of the endoscope 2. In this case, an additional camera objective with image sensor can be housed at the end of the endoscope 2.

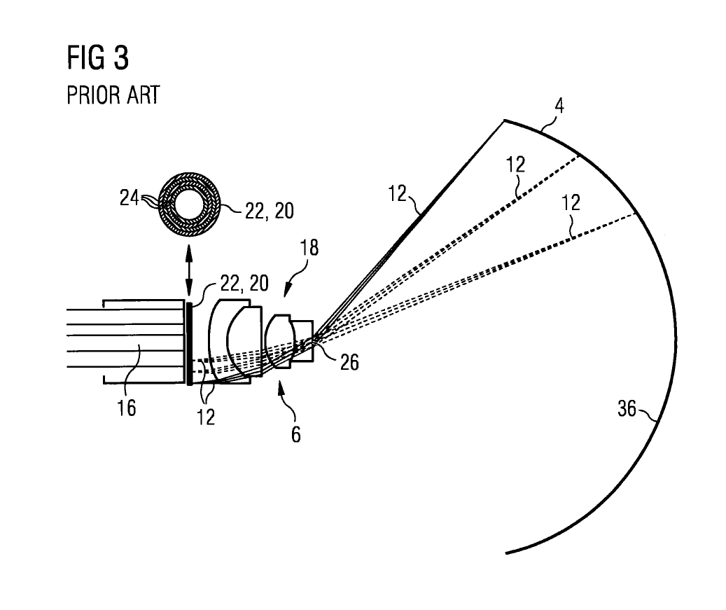

In the following text, the projection unit 6 and a projection optical unit 18 should be discussed in more detail on the basis of FIG. 3. The projection unit 6 comprises a light source, which in this case is advantageously embodied in the form of an optical waveguide or optical waveguide bundle 16. A projection structure 20, embodied here as a slide 22, is arranged upstream of the light source. The slide 22 in FIG. 3 has a plurality of concentric colored rings 24. In addition to the cross section through the slide 22, FIG. 3 also provides a top view of the slide 22; the latter serves for better illustration of the arrangement of the concentric colored rings 24. In principle, the projection structure 20 can also be embodied in the form of a colored or otherwise designed line structure. The embodiment illustrated here is the so-called color coded triangulation method, wherein the colored rings 24 (usually numbering between 15 and 25, preferably numbering approximately 20) form a color-coded ring pattern.

The projection beams 12, which come from the optical waveguide 16 and are in this example emitted by an LED (not illustrated here), extend virtually perpendicularly through the slide 22, are deflected by a suitable projection optical unit 18 and meet in a pupil 26 such that the chief rays in each case meet in virtually punctiform fashion in the pupil 26. This is referred to as a slide-side telecentric projector unit.

Going forward, the individual projection beams 12 separate again according to their color and impinge on the surface 4 to be measured as a colored pattern. The surface 4 to be measured is now illustrated in FIG. 3 as a circular field. The fanning of the projection beams 12 results in a so-called projection space 36.

As a result of the irregular topography of the surface 4 (which is not illustrated here), the projection beams 12, which once extended in parallel when passing through the slide 22, now impinge on the surface 4 at different distances from the projection objective. From a different viewing direction, the projection image reflected on the surface 4 appears to be distorted and is imaged by (not illustrated in any more detail here) an imaging medium 28, wherein a suitable evaluation method can be used to determine the topography of the surface 4 numerically by evaluating the color transitions and the distortion of the color lines.

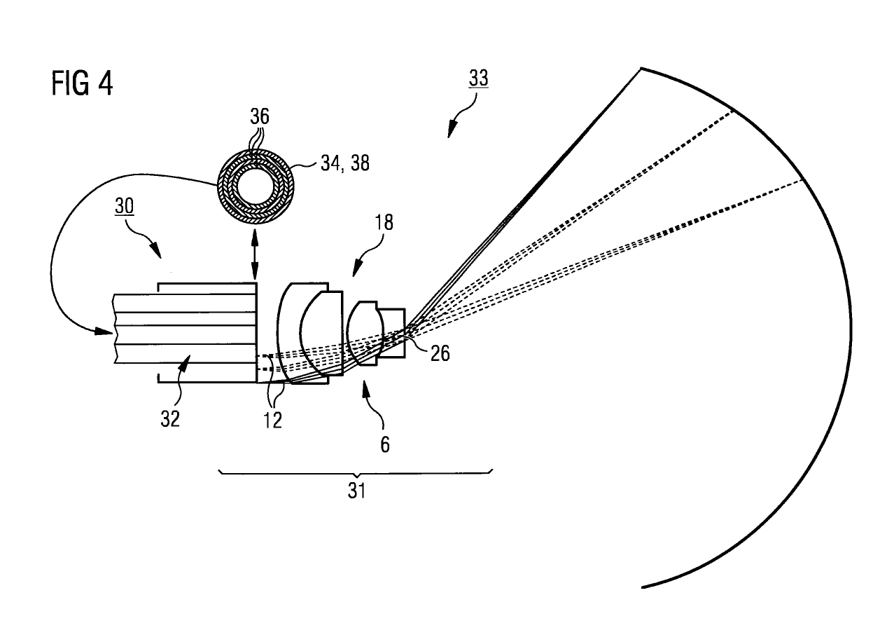

However, since—as explained at the outset—the measurement method according to CCT does not provide as high a resolution as phase triangulation, the latter in principle imposes itself; however, in the case of an endoscope according to FIGS. 1 to 3, it would require the slide 20 to be replaced at least twice by a phase-shifted slide or to be shifted in a defined fashion in respect of the phase angle by a mechanical device. Since this procedure cannot be undertaken with justifiable effort, particularly in constricted spatial conditions, a first projection unit 30, as per FIG. 4, has a coherent fiber bundle 32 as image guide, into which a projection structure 34 is coupled on the input side. This projection structure 34 has a sinusoidal intensity modulation in the radial direction for the annular strips 36. Hence, the projection structure 34 can be generated far from the actual head 31 of an endoscope 33 by any display 38 and then be coupled into the fiber bundle 32. This renders it possible, away from the head, to generate sequences of phase-structured images which are phase-shifted with respect to one another, and to project these onto the surface 4 to be measured via the projection unit 30.

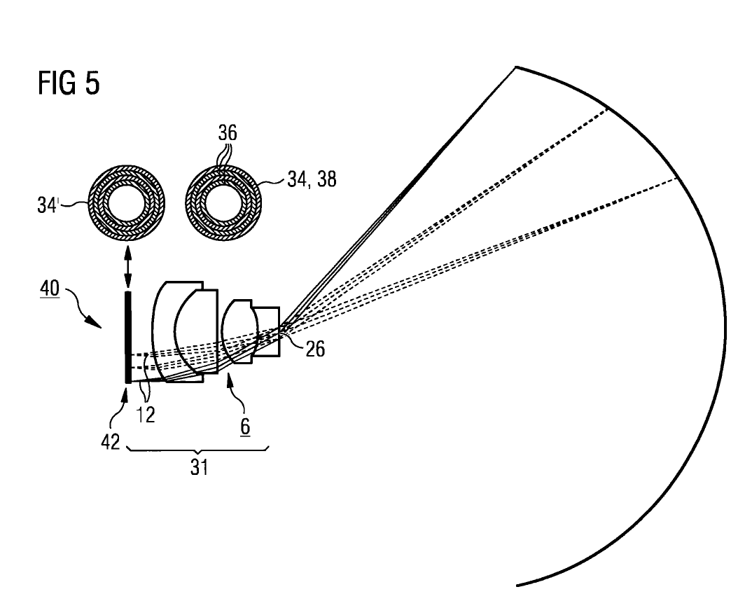

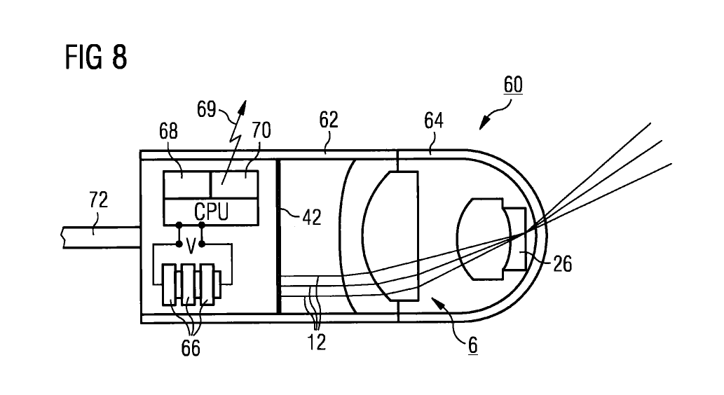

FIG. 5 shows a schematic illustration of a second projection unit 40 with a beam path and a phase-structured image projection by a light-emitting OLED display 42. As a result of an appropriate actuation of the OLED display 42, it is possible to generate both the projection structure 34 and a color-ring encoded projection structure 34′ directly in the head of the endoscope. Therefore, apart from the feed lines to the OLED display 42, this telecentric projection unit 40 requires no further components in the head of the endoscope. As a result, this variant renders it possible to be able to design an endoscope head 60 to be capsule-shaped and to be autonomous in respect of operation in the case of an appropriate battery 66 being implanted into a capsule 62, as shown in FIG. 8. The recorded data can be stored locally in a storage medium 68 on the capsule 62 by a control unit CPU, and can be evaluated later. Alternatively, or else in addition thereto, it is also made possible in this case for this data 69 to be directly transmitted wirelessly to an evaluation unit (not illustrated in any more detail here) by a radio-communication module 70. Here, the capsule 62 has a transparent cover 64, e.g. in the style of a glass ampoule, in the front part which is filled by the projection unit. The endoscope head 60 thus embodied in an autonomous fashion, then only still has a guidance-guide 72, by which it can be navigated in the space to be measured.

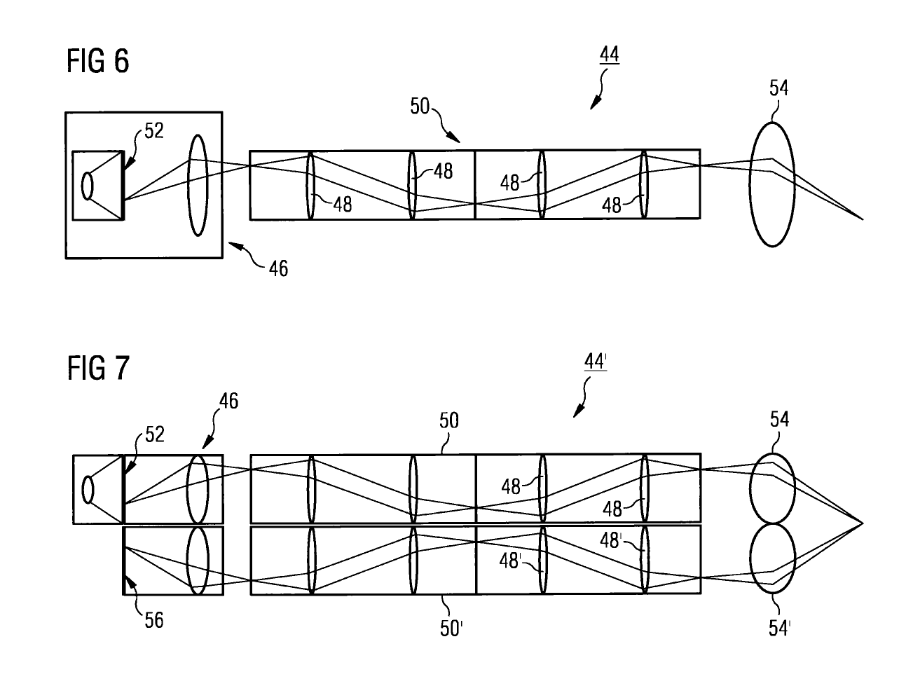

FIG. 6 now shows a schematic illustration of a first endoscope 44 with a projector 46 with a beam path and a phase-structured image projection by an image guide 50 constructed from rod lenses 48. A phase-structured image (phase structure 34) generated by an LCD screen 52 is thus generated at a distance from the head and is routed to a projection optical unit 54 in the head of the endoscope 44 via the image guide 50.

FIG. 7 shows a schematic illustration of a second endoscope 44′ with the projector 46 with a beam path and a phase-structured image projection by rod lenses 48 for image feed and an image return to a camera 56 by rod lenses 48′. Hence this endoscope 44′ supplements the endoscope 44 as per FIG. 6 by a corresponding mirrored optical unit for returning the reflection of the image projected onto the surface 4 to be measured.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-13. (canceled)

14. An endoscope for measuring topography of a surface, comprising:
a movable measuring head which can be made to approach the surface;
a projection unit provided in the measuring head, to project images onto the surface;
an imaging unit;
an image generating unit to generate the images, which are projected on the surface, the image generating unit being arranged outside of the measuring head; and
an image guide to transmit the images in a phase-structured fashion, from the image generating unit to the projection unit.

15. The endoscope as claimed in claim 14, wherein the image generating unit comprises a projection module.

16. The endoscope as claimed in claim 14, wherein the image guide comprises a lens arrangement.

17. The endoscope as claimed in claim 14, wherein the image guide comprises a coherent fiber bundle.

18. The endoscope as claimed in claim 17, wherein the images projected onto the surface are reflected and returned for measurement, via the coherent fiber bundle.

19. The endoscope as claimed in claim 14, wherein the imaging unit is provided in the measuring head.

20. The endoscope as claimed in claim 14, wherein the topography is measured by active triangulation.

21. The endoscope as claimed in claim 14, wherein the images projected have a radially symmetric structure.

22. The endoscope as claimed in claim 14, wherein
the images projected have an annular sinusoidal lattice, and
the images projected have a radially outward sinusoidal profile from the center.

23. The endoscope as claimed in claim 14, wherein the imaging unit has a digital camera sensor chip as an imaging medium.

24. An endoscope for measuring topography of a surface, comprising:
a movable measuring head which can be made to approach the surface; and
a projection unit provided in the measuring head, to project images onto the surface, the projection unit comprising an image generating unit embodied as light-emitting display to emit phase-structured image sequences; and
an imaging unit.

25. The endoscope as claimed in claim 24, wherein the light-emitting display is an OLED.

26. The endoscope as claimed in claim 24, wherein
the measuring head is a capsule-shaped endoscope head, and
the projection unit and the imaging unit are arranged in the capsule-shaped endoscope head together with:
a battery; and
at least one of a storage unit and a wireless data transmitter.

27. The endoscope as claimed in claim 24, wherein the topography is measured by active triangulation.

28. The endoscope as claimed in claim 24, wherein the images projected have a radially symmetric structure.

29. The endoscope as claimed in claim 24, wherein
the images projected have an annular sinusoidal lattice, and
the images projected have a radially outward sinusoidal profile from the center.

30. The endoscope as claimed in claim 24, wherein the imaging unit has a digital camera sensor chip as an imaging medium.

31. The endoscope as claimed in claim 24, wherein the imaging unit is provided in the measuring head.

32. A method for measuring topography of a surface using an endoscope, comprising:
generating phase-structured image sequences either:
near a head of the endoscope using a light-emitting display, or
at a distance from the head of the endoscope using a downstream image guide to transmit the image sequences to the head of the endoscope;
projecting the image sequences onto the surface, using a projection unit provided in the head of the endoscope; and
measuring images reflected by the surface.
